(19) United States
(12) Patent Application Publication
(10) Pub. No.: US 2013/0237317 A1
(43) Pub. Date: Sep. 12, 2013

(54) METHOD AND APPARATUS FOR DETERMINING CONTENT TYPE OF VIDEO CONTENT

(71) Applicant: SAMSUNG ELECTRONICS CO., LTD., Suwon-si (KR)

(72) Inventors: Mikhail Rychagov, Moscow (RU); Sergey Sedunov, Moscow (RU); Xenya Petrova, Moscow (RU)

(73) Assignee: Samsung Electronics Co., Ltd., Suwon-si (KR)

(21) Appl. No.: 13/795,716

(22) Filed: Mar. 12, 2013

(30) Foreign Application Priority Data
Mar. 12, 2012 (RU) 2012109119
Nov. 7, 2012 (KR) 10-2012-0125698
Jan. 24, 2013 (KR) 10-2013-0008212

(51) Int. Cl. A63F 13/00

(52) U.S. Cl. CPC A63F 13/00
USPC 463/31; 382/162

(57) ABSTRACT

Provided is a method of determining a content type of a video content. The method includes: receiving a frame of the video content; detecting a pixel-by-pixel color component characteristic of the received frame; and determining a content type of the received frame according to the pixel-by-pixel color component characteristic indicating whether the received frame includes a content that reproduces a scene of a predetermined genre.

### CROSS-REFERENCE TO RELATED PATENT APPLICATION

This application claims the benefit of Russian Patent Application No. 2012109119, filed on Mar. 12, 2012, in the Russian Patent Office, Korean Patent Application No. 10-2012-0125698, filed on Nov. 7, 2012, in the Korean Intellectual Property Office, and Korean Patent Application No. 10-2013-0008212, filed on Jan. 24, 2013, in the Korean Intellectual Property Office, the disclosures of which are incorporated herein in their entirety by reference.

### BACKGROUND OF THE INVENTION

1. Field of the Invention

The present invention relates to a method and apparatus for determining a content type of a video content, and more particularly, to a method and apparatus for determining whether a field game is included in each frame of a video content.

2. Description of the Related Art

Before being displayed on a display unit, a video content may undergo a process such as luminance/contrast enhancement or sharpening. In this case, the video content may be processed in consideration of a genre or a type of the video content.

There exists a method of detecting a type of a video content by using an auditory characteristic of the video content. However, the method has a problem in that when a video track and an audio track are separately stored, the method may not be used.

Also, there exists a method of detecting a type of a video content segment by segment. However, the method has a problem in that since a type of the video content has to be detected in consideration of one or more frames included in a segment, it takes a long time.

Accordingly, there is a demand for a method of rapidly detecting a type of a video content frame by frame.

### SUMMARY OF THE INVENTION

The present invention provides a method of determining a type of a video content frame by frame of the video content, and also provides a method of determining whether a field game is included frame by frame of a video content.

According to an aspect of the present invention, there is provided a method of determining a content type of a video content, the method including: receiving a frame of the video content; detecting a pixel-by-pixel color component characteristic of the received frame; and determining a content type of the received frame according to the detected pixel-by-pixel color component characteristic, wherein the determining indicates whether the received frame includes a content that reproduces a scene of a predetermined genre.

When the received frame and a previous frame belong to a same scene, the method may further include determining the content type of the received frame according to a content type of the previous frame.

The detecting of the pixel-by-pixel color component characteristic of the received frame may include: detecting a luminance and a saturation of each of a plurality of pixels included in the received frame; detecting the pixel-by-pixel color component characteristic by using the detected luminance and the detected saturation and an RGB channel value of the each of the plurality of the pixels; detecting a gradient of the luminance of the each of the plurality of the pixels by respectively using the detected luminance of the each of the plurality of the pixels; and detecting a statistical analysis value of the received frame by using the detected gradient of the luminance of the each of the plurality of the pixels and the pixel-by-pixel color component characteristic detected by using the detected luminance and the detected saturation and the RGB channel value of the each of the plurality of the pixels.

The detecting of the statistical analysis value of the received frame may include: detecting a statistical analysis value of the plurality of the pixels included in the received frame; and detecting a statistical analysis value of pixels whose pixel-by-pixel color component characteristic is green from among the plurality of the pixels included in the received frame.

The detecting of the statistical analysis value of the plurality of the pixels included in the received frame may include: detecting a proportion of pixels whose pixel-by-pixel color component characteristic is white from among the plurality of the pixels included in the received frame; detecting a proportion of pixels whose pixel-by-pixel color component characteristic is bright and saturated from among the plurality of the pixels included in the received frame; detecting a proportion of pixels whose pixel-by-pixel color component characteristic is green from among the plurality of the pixels included in the received frame; and detecting a proportion of pixels whose pixel-by-pixel color component characteristic is skin tone from among the plurality of the pixels included in the received frame.

The detecting of the statistical analysis value of the pixels whose pixel-by-pixel color component characteristic is green from among the plurality of the pixels included in the received frame may include: detecting an average luminance value of a plurality of the pixels whose pixel-by-pixel color component characteristic is green from among the plurality of the pixels included in the received frame; detecting an average saturation value of the plurality of the pixels whose pixel-by-pixel color component characteristic is green from among the plurality of pixels included in the received frame; detecting an average B channel value of the plurality of the pixels whose pixel-by-pixel color component characteristic is green from among the plurality of pixels included in the received frame; detecting an average luminance gradient of the plurality of the pixels whose pixel-by-pixel color component characteristic is green from among the plurality of pixels included in the received frame; and detecting a histogram of a G channel of the plurality of pixels whose pixel-by-pixel color component characteristic is green from among the plurality of pixels included in the received frame;

The determining of the content type of the received frame according to the detected pixel-by-pixel color component characteristic may include, from among a plurality of pixels included in the received frame, in at least one case from among a case where a proportion of pixels whose pixel-by-pixel color component characteristic is green is equal to or less than a reference value, a case where an average saturation value of the pixels whose pixel-by-pixel color component characteristic is green is equal to or less than a saturation reference value, a case where the average saturation value of the pixels whose pixel-by-pixel color component characteristic is green is equal to or less than the saturation reference value, and an average value of a B channel of the pixels whose pixel-by-pixel color component characteristic is green is equal to or greater than a B channel reference value, a case where the average saturation value or an average luminance value of the pixels whose pixel-by-pixel color component characteristic is green is equal to or less than the saturation reference value or a luminance reference value, respectively, a case where the average saturation value of the pixels whose pixel-by-pixel color component characteristic is green is a value between a first reference value and a second reference value, and a width of a histogram of the pixels whose pixel-by-pixel color component characteristic is green is equal to or greater than a width reference value, a case where the average saturation value of pixels whose pixel-by-pixel color component characteristic is green is equal to or greater than a reference value, and the width of the histogram of the pixels whose pixel-by-pixel color component characteristic is green is equal to or less than a reference value, and a case where the average saturation value of the pixels whose pixel-by-pixel color component characteristic is green is equal to or greater than a reference value, and an average gradient of a luminance of the pixels whose pixel-by-pixel color component characteristic is green is equal to or less than a gradient reference value, determining that the content type of the received frame is a non-field game.

The determining of the content type of the received frame according to the detected pixel-by-pixel color component characteristic may include, from among the plurality of the pixels included in the received frame: in at least one case from among a case where a proportion of pixels whose pixel-by-pixel color component characteristic is green is equal to or less than a reference value, a proportion of pixels whose pixel-by-pixel color component characteristic is bright and saturated is equal to or greater than the reference value, and a proportion of pixels whose pixel-by-pixel color component characteristic is white or a proportion of pixels whose pixel-by-pixel color component characteristic is skin tone is equal to or less than the reference value, and a case where a proportion of pixels whose pixel-by-pixel color component characteristic is green is equal to or greater than reference value, a proportion of pixels whose pixel-by-pixel color component characteristic is bright and saturated is equal to or less than the reference value, and a proportion of the pixels whose pixel-by-pixel color component characteristic is white or a proportion of the pixels whose pixel-by-pixel color component characteristic is skin tone is equal to or less than the reference value, determining that the content type of the received frame is a field game.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of determining a content type of a video content, according to an embodiment of the present invention;

FIG. 2 is a flowchart illustrating a method of detecting a pixel-by-pixel color component characteristic of a video content, according to an embodiment of the present invention;

FIG. 3 is a flowchart illustrating a method of detecting a statistical analysis value included in one frame of a video content, according to an embodiment of the present invention;

FIG. 4 is a flowchart illustrating a method of determining a content type of a video content, according to another embodiment of the present invention, in which a content type of a current frame may be determined according to a content type of a previous frame;

FIG. 5 is a block diagram illustrating a content type determination apparatus for determining a content type of a video content, according to an embodiment of the present invention;

FIG. 6 is a block diagram illustrating a content type determination apparatus for determining a content type of a video content, according to another embodiment of the present invention;

FIG. 7 is a block diagram illustrating a pixel-by-pixel color component characteristic detecting unit of a content type determination apparatus, according to an embodiment of the present invention;

FIG. 8 is a block diagram illustrating a pixel classifying unit of a pixel-by-pixel color component characteristic detecting unit, according to an embodiment of the present invention;

FIG. 9 is a block diagram illustrating a content type detecting unit of a content type determination apparatus, according to an embodiment of the present invention;

FIG. 10 is a block diagram illustrating a scene change detecting unit of a content type determining apparatus, according to an embodiment of the present invention;

FIG. 11 is a block diagram illustrating a final type detecting unit of a content type determination apparatus, according to an embodiment of the present invention;

FIG. 12 is a block diagram illustrating a content type determination system according to an embodiment of the present invention;

FIG. 13 is a graph illustrating an area in which a field game episode may be included, according to an embodiment of the present invention;

FIG. 14 is a graph illustrating a range of RGB channel data values in which a pixel may be determined to be a white pixel, according to an embodiment of the present invention;

FIG. 15 is a graph illustrating a range of RGB channel data values in which a pixel may be determined to be a skin tone pixel, according to an embodiment of the present invention;

FIG. 16 is a graph illustrating a range of RGB channel data values in which a pixel may be determined to be a yellow pixel, according to an embodiment of the present invention;

FIG. 17 is a graph illustrating a range of RGB channel data values in which a pixel may be determined to be a green pixel, according to an embodiment of the present invention;

FIGS. 18A and 18B are luminance graphs of green pixels, according to embodiments of the present invention;

FIGS. 19A through 20B illustrate images not corresponding to a field game episode and graphs of the images, according to embodiments of the present invention;

FIGS. 21A and 21B illustrate an image not corresponding to a field game episode and a graph of the image, according to another embodiment of the present invention;

FIGS. 22A through 23B illustrate images corresponding to a field game episode and graphs of the images, according to embodiments of the present invention; and

FIGS. 24A and 24B illustrate an image that is determined to be a non-field game episode and is inserted between an image determined to be a non-field game episode and an image corresponding to a field game episode, and a graph of the image.

### DETAILED DESCRIPTION OF THE INVENTION

Expressions such as “at least one of,” when preceding a list of elements, modify the entire list of elements and do not modify the individual elements of the list.

The present invention will now be described more fully with reference to the accompanying drawings, in which exemplary embodiments of the invention are shown. In the description of the present invention, certain detailed explanations of related art are omitted when it is deemed that they may unnecessarily obscure the essence of the invention. In the drawings, the same elements are denoted by the same reference numerals.

The terms and words which are used in the present specification and the appended claims should not be construed as being confined to common meanings or dictionary meanings but should be construed as meanings and concepts matching the technical spirit of the present invention in order to describe the present invention in the best fashion. Therefore, the embodiments and structure described in the drawings of the present specification are just exemplary embodiments of the present invention, and they do not represent the entire technological concept and scope of the present invention. Therefore, it should be understood that there can be many equivalents and modified embodiments that can substitute those described in this specification.

The present invention relates to a method of determining a content type of a video content, and more particularly, to a method of detecting whether a field game episode of a video content is included.

According to the present invention, a content type may be detected based on the fact that a proportion of green pixels of a content including a field game episode is higher than that of a content not including a field game episode.

In general, a proportion or a saturation of green pixels included in a frame of a content including a field game episode is higher than that of a content not including a field game episode.

However, in some cases, a saturation of green pixels in a content including a field game episode may be lower than that of a content not including a field game episode. That is, it may not be absolutely true that since a saturation of green pixels is high, a content includes a field game episode. A human may easily determine that a content includes a field game episode even when a saturation of green pixels of the content is low. In this case, blue components of pixels may play a key role in the determination. This is because color of blue pixels are almost similar to color of green pixels. Hence, an average value of a B channel in green pixel areas may be used to detect a content type for detecting whether a field game episode of a video content is included. The green pixel areas may refer to pixels in a range in which pixel values may be recognized by a human as green.

Also, an average luminance value of frames of a content may also be used to determine whether a field game episode is included. This is because sport events are usually held in bright places.

A video content including a field game episode has a relatively narrow histogram of a G channel of an RGB signal in green pixel areas. This is because in a field game, a grass field having a uniform color may be used. Accordingly, a histogram of a G channel of each pixel of a frame may also be used to determine whether a field game episode is included.

In an image including a field game episode, a gradient of a luminance value of each pixel included in green pixel areas is relatively high. This is because the color of uniforms of players that is an aposematic line in a field game is often conspicuous, and thus is clearly distinguished from a grass field. Accordingly, a gradient of a luminance value of each pixel of a frame may be used to determine whether a field game episode is included.

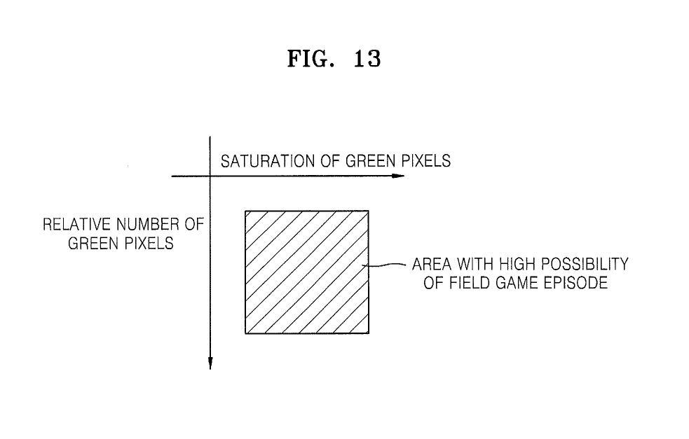

FIG. 13 is a graph illustrating an area in which a field game episode may be included, according to an embodiment of the present invention.

Referring to FIG. 13, when a saturation of green pixels included in a frame of a content is low or when a number of green pixels is relatively low, a possibility that the frame of the content does not include a field game episode is high. A green pixel may include a pixel included in an area in which a value of RGB channel data of the pixel may be recognized by a human as green.

In the present invention, a case where one frame may be determined to be a field game episode may be classified into three cases: a case where a far view is presented, a case where a close-up view is presented, and a case where when a previous frame is determined to be a field game episode, a scene change does not occur.

When a number of green pixels is relatively high, a number of bright and saturated pixels is low, and a number of white pixels or skin tone pixels is greater than 0 but very low, in other words, when a proportion of green pixels of a frame is equal to or greater than a reference value, a proportion of bright and saturated pixels is equal to or less than the reference value, and a proportion of white pixels or a proportion of skin tone pixels is equal to or less than the reference value, a content type of a frame may be determined to be a field game episode of a far view. In this case, the green pixels may correspond to a color of a grass field of a field game, and the bright and saturated pixels and the white pixels may correspond to a color of a uniform of a player. Also, the skin tone pixels may correspond to a skin tone of the player.

When a number of green pixels is relatively low, a number of bright and saturated pixels is high, a number of white pixels is low, and a number of skin tone pixels is greater than 0 but very low, in other words, when a proportion of green pixels is equal to or less than a reference value, a proportion of bright and saturated pixels is equal to or greater than the reference value, and a proportion of white pixels or a proportion of skin tone pixels is equal to or less than the reference value, a content type of a frame may be determined to a be field game episode of a close-up view. This is because a player may be largely displayed by being zoomed in on at a close range in the close-up view.

A content type of a frame may be determined to be a field game episode according to whether a scene change occurs. When a content type of a previous frame is classified as a field game episode and a scene change does not occur, a content type of a current frame may be determined to be a field game episode.

In the present invention, a case where a content type of a frame may be determined to be a non-field game episode may be classified into 7 cases.

When a proportion of green pixels included in a frame is low, an average luminance value of green pixels is low or an average saturation value of green pixels is very low, and the content type of the frame may be determined to be a non-field game episode as described above.

As shown in the graph of FIG. 13, case where a proportion of green pixels included in a frame is low or an average saturation value of green pixels included in the frame is very low may be included in an area other than an area in which the frame may be determined to be a non-field game episode.

When an average saturation value of green pixels included in a frame is low and an average value of a B channel of the green pixels is high, a content type of the frame may be determined to be a non-field game episode.

When an average saturation value of green pixels included in a frame is a medium value and a histogram of a G channel value of the green pixels has a wide width, a content type of the frame may be determined to be a non-field game episode.

When an average saturation value of green pixels included in a frame is very high and a histogram of a G channel value of the green pixels has a very narrow width, a content type of the frame may be determined to be a non-field game episode.

When an average saturation value of green pixels included in a frame is high and an average value of a gradient of a luminance value of the green pixels is very low, a content type of the frame may be determined to be a non-field game episode.

In cases other than the above 7 cases where a content type may be determined to be a non-field game episode, that is, in at least one case from among 3 cases where a content type may be determined to be a field game episode: a case where a far view is presented, a case where a close-up view is presented, and a case where when a content type of a previous frame is determined to be a field game episode, a scene change does not occur, a content type of a current frame may be determined to be a field game episode.

In a case that is not included in the 7 cases where a content type may be determined to be a non-field game episode and in the 3 cases where a content type may be determined to be a field game episode, a content type of a frame may be determined to be a non-field game episode.

In a case that is included in both the 7 cases where a content type may be determined to be a non-field game episode and the 3 cases where a content type may be determined to be a field game episode, a content type of a frame may be determined to be a non-field game episode.

FIG. 1 is a flowchart illustrating a method of determining a content type of a video content, according to an embodiment of the present invention.

Referring to FIG. 1, in operation S101, a content type determination apparatus receives a frame of a video content from the outside. In operation S103, the content type determination apparatus may detect a pixel-by-pixel color component characteristic of each of pixels included in the frame. The pixel-by-pixel color component characteristic may include a saturation, a luminance, a gradient of a luminance value, white color, skin tone, yellow, and green, or bright and saturated.

In operation S105, the content type determination apparatus may determine a content type according to the pixel-by-pixel color component characteristic. In this case, the content type may be determined frame by frame, and according to whether the content includes a field game episode.

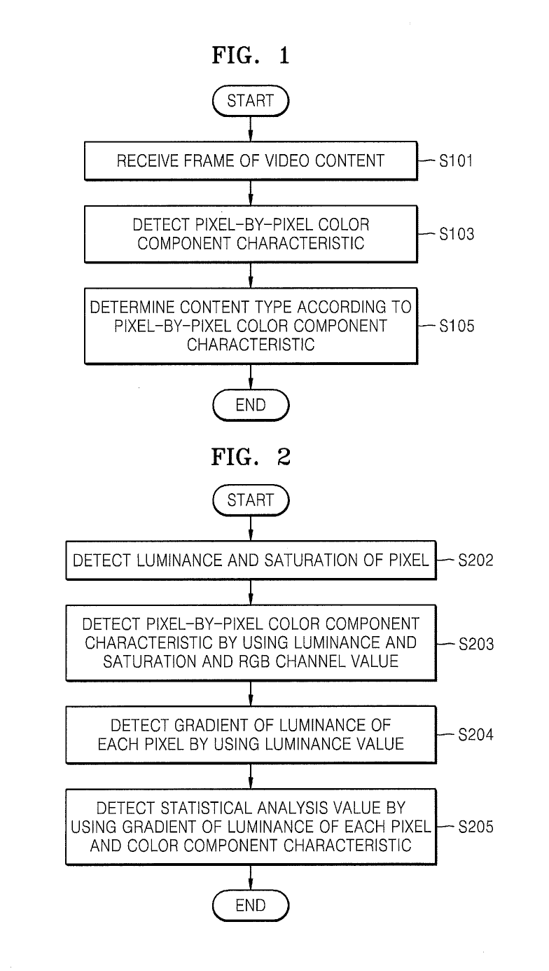

FIG. 2 is a flowchart illustrating a method of detecting a pixel-by-pixel color component characteristic of a video content, according to an embodiment of the present invention.

Referring to FIG. 2, in operation S202, a content type determination apparatus detects a luminance and a saturation of each of pixels included in one frame of a video content. In operation S203, the content type determination apparatus may detect a pixel-by-pixel color component characteristic by using the luminance and the saturation of each pixel and an RGB channel value of each pixel. In operation S204, the content type determination apparatus may detect a gradient of the luminance of each pixel by using a luminance value of each pixel. The pixel-by-pixel color component characteristic may be detected according to the luminance, the saturation, and the RGB channel value of each pixel. In operation S203, it may be determined whether a corresponding pixel has a characteristic such as white, skin tone, yellow, green, or bright and saturated as the pixel-by-pixel color component characteristic.

Also, in operation S205, the content type determination apparatus may detect a statistical analysis value of pixels included in one frame of a video content by using the pixel-by-pixel color component characteristic detected in operation S203 and the gradient of the luminance of each pixel detected in operation S204. The statistical analysis value in operation S205 refers to a value obtained by analyzing a characteristic of a frame by using a characteristic of each pixel, and may include a number of green pixels of one frame, a number of skin tone pixels, an average luminance value, a number of bright and saturated pixels, and a number of white pixels. A content type of one frame of the video content may be determined according to the statistical analysis value detected in operation S205.

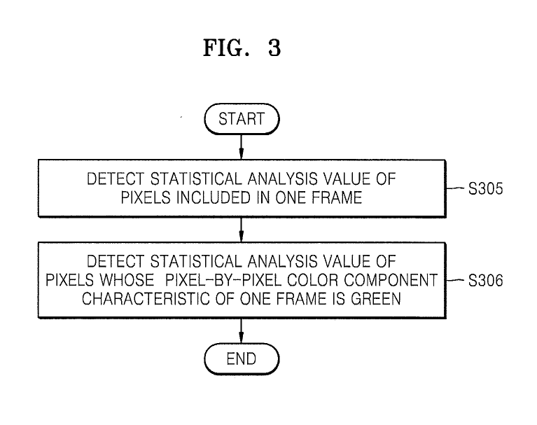

FIG. 3 is a flowchart illustrating a method of detecting a statistical analysis value included in one frame of a video content, according to an embodiment of the present invention.

Referring to FIG. 3, in operation S305, a content type determination apparatus detects a statistical analysis value of pixels included in one frame. In operation S306, the content type determination apparatus detects a statistical analysis value of green pixels from among the pixels included in one frame, thereby detecting one or more statistical analysis values included in one frame of a video content. The statistical analysis value of the green pixels may include an average of a gradient of a luminance value of the green pixels, an average saturation value of the green pixels, an average brightness value of the green pixels, an average value of a B channel value of the green pixels, and a relative width of a luminance histogram of the green pixels.

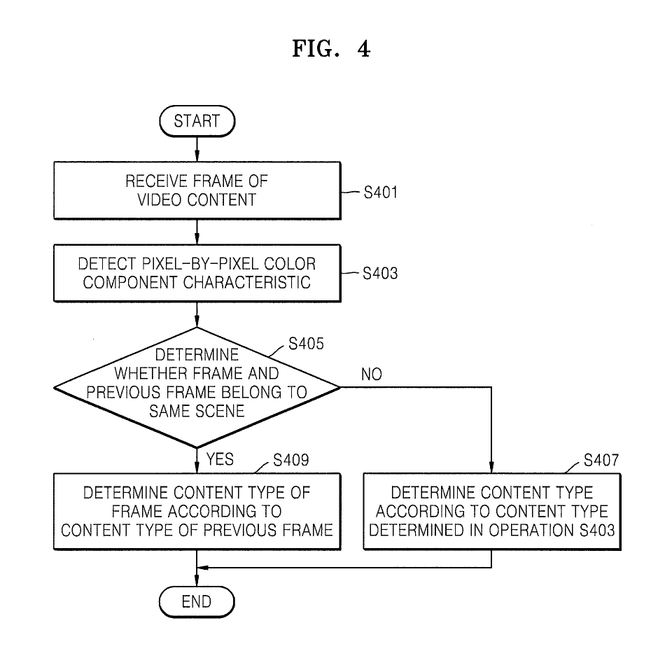

FIG. 4 is a flowchart illustrating a method of determining a content type of a video content, according to another embodiment of the present invention. A content type of a current frame may be determined according to a content type of a previous frame.

Referring to FIG. 4, in operation S401, a content type determination apparatus may receive a frame of a video content from the outside. In operation S403, the content type determination apparatus may detect color component characteristics of pixels included in the frame, and may detect a content type of a current frame according to a pixel-by-pixel color component characteristic. In operation S405, the content type determination apparatus determines whether the current frame and a previous frame belong to the same scene. When it is determined in operation S405 that the current frame and the previous frame belong to the same scene, the method proceeds to operation S409. In operation S409, the content type determination apparatus may determine a content type of the frame according to a content type of the previous frame. However, when it is determined in operation S405 that the current frame and the previous frame do not belong to the same scene, that is, a scene change occurs, the method proceeds to operation S407. In operation S407, a content type of the current frame may be finally determined according to the content type detected in operation S403.

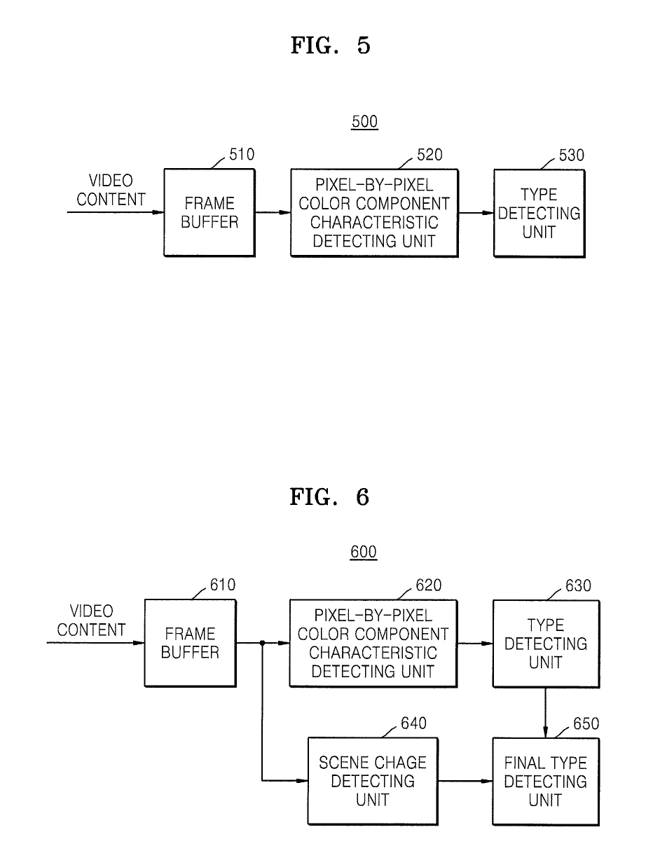

FIG. 5 is a block diagram illustrating a content type determination apparatus 500 for determining a content type of a video content, according to an embodiment of the present invention.

Referring to FIG. 5, the content type determination apparatus 500 may include a frame buffer 510, a pixel-by-pixel color component characteristic detecting unit 520, and a type detecting unit 530.

The frame buffer 510 may receive a video content from the outside and may transmit the video content to the pixel-by-pixel color component characteristic detecting unit 520 one frame by one frame.

The pixel-by-pixel color component characteristic detecting unit 520 may receive the video content from the frame buffer 510 one frame by one frame, and may detect a pixel-by-pixel color component characteristic of each pixel included in each frame.

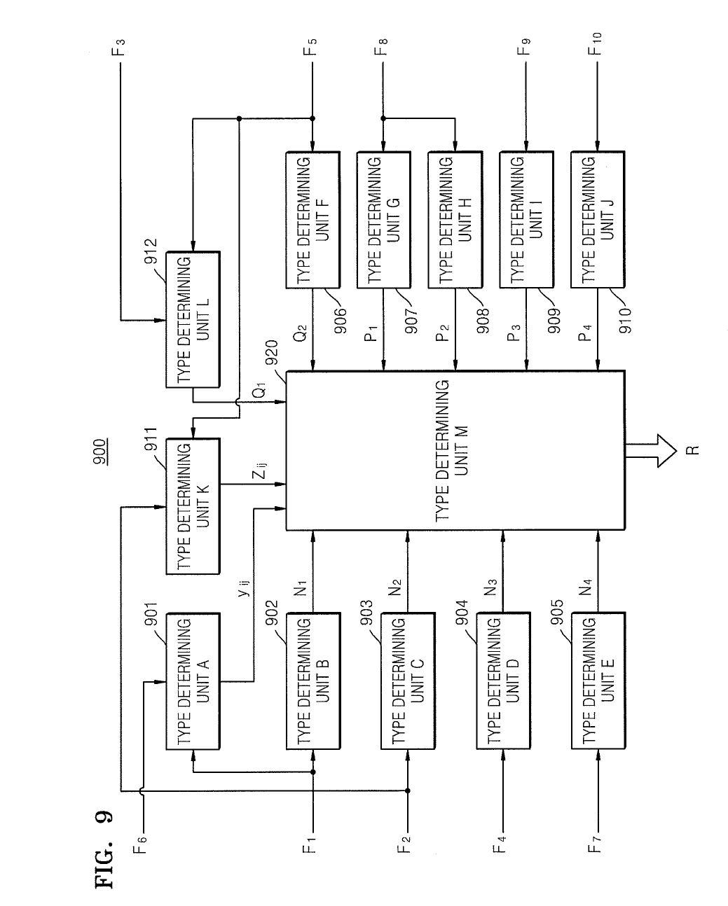

The type detecting unit 530 may determine a content type according to the pixel-by-pixel color component characteristic detected by the pixel-by-pixel color component characteristic detecting unit 520. In this case, the content type may be determined frame by frame, and according to whether the content includes a field game. A method of determining a content type that is performed by the type determining unit 530 will be explained below in detail with reference to FIG. 9.

FIG. 6 is a block diagram illustrating a content type determination apparatus 600 for determining a content type of a video content, according to another embodiment of the present invention.

In FIG. 6, a content type of a current frame may be determined according to a content type of a previous frame. The content type determination apparatus 600 of FIG. 6 may correspond to the content type determination apparatus 500 of FIG. 5.

Referring to FIG. 6, the content type determination apparatus 600 may include a frame buffer 610, a pixel-by-pixel color component characteristic detecting unit 620, a type detecting unit 630, a scene change detecting unit 640, and a final type detecting unit 650. The frame buffer 610, the pixel-by-pixel color component characteristic detecting unit 620, and the type detecting unit 630 respectively correspond to the frame buffer 510, the pixel-by-pixel color component characteristic detecting unit 520, and the type detecting unit 530 of FIG. 5, and thus a repeated explanation will not be given.

The scene change detecting unit 640 outputs a value ‘False’ when a current frame and a previous frame belong to the same scene, and outputs a value ‘True’ when the current frame and the previous frame do not belong to the same scene, to provide information whether a scene change occurs.

The final type detecting unit 650 may detect a content type of the current frame according to an output value of the scene change detecting unit 640. A value output from the scene change detecting unit 640 is ‘True’ or ‘False’, and ‘True’ is a value which may be output when a scene change occurs and ‘False’ is a value which may be output when a scene change does not occur. In this case, the final type detecting unit 650 may output a content type value detected for the current frame when an output value of the scene change detecting unit 640 is ‘True’ and may output a content type value detected for the previous frame when an output value of the scene change detecting unit 640 is ‘False’.

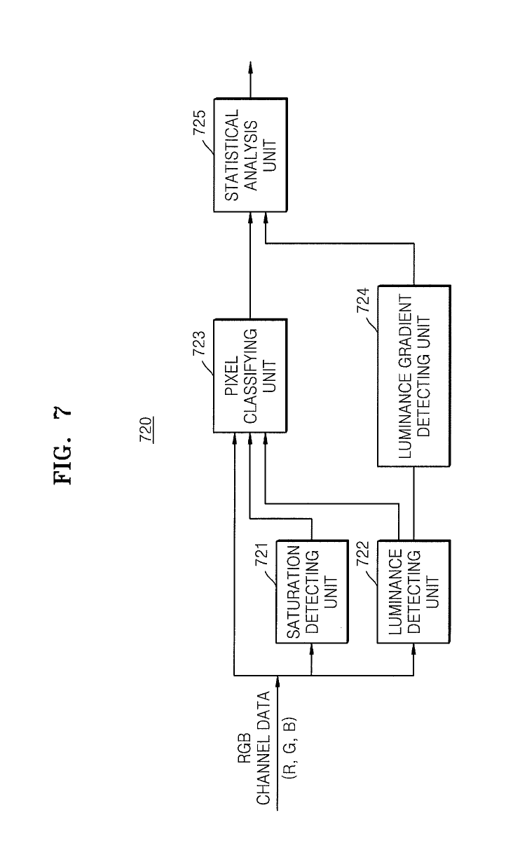

FIG. 7 is a block diagram illustrating a pixel-by-pixel color component characteristic detecting unit 720 of a content type determination apparatus, according to an embodiment of the present invention.

The pixel-by-pixel color component characteristic detecting unit 720 of FIG. 7 may correspond to each of the pixel-by-pixel color component characteristic detecting units 520 and 620 of FIGS. 5 and 6.

Referring to FIG. 7, the pixel-by-pixel color component characteristic detecting unit 720 may include a saturation detecting unit 721, a luminance detecting unit 722, a pixel classifying unit 723, a luminance gradient detecting unit 724, and a statistical analysis unit 725.

The saturation detecting unit 721 may detect a saturation of at least one pixel included in one frame received by the pixel-by-pixel color component characteristic detecting unit 720. The saturation detecting unit 721 may detect a saturation of each pixel by using RGB channel data R, G, and B of each pixel. In this case, a saturation value S may be detected as shown in Equation 1.

$$When M 0 = MIN ( R , G , B ) , \\ M 1 = MAX ( R , G , B ) , \\ S = \{ \begin{matrix}1 - \frac{M 0}{M 1} , & M 1 > 0 \\ 0 , & otherwise ,\end{matrix} \qquad ( 1 )$$

where M0 may be a minimum channel value of RGB channel data of a pixel, and M1 may be a maximum channel value of the RGB channel data of the pixel.

The luminance detecting unit 722 may detect a luminance of at least one pixel included in one frame received by the pixel-by-pixel color component characteristic detecting unit 720. The luminance detecting unit 722 may detect a luminance of each pixel by using RGB channel data R, G, and B of each pixel. In this case, a luminance value Y of each pixel may be detected as shown in Equation 2.

$$Y = \frac{306 R}{1024} + \frac{601 G}{1024} + \frac{58 B}{512} . \qquad ( 2 )$$

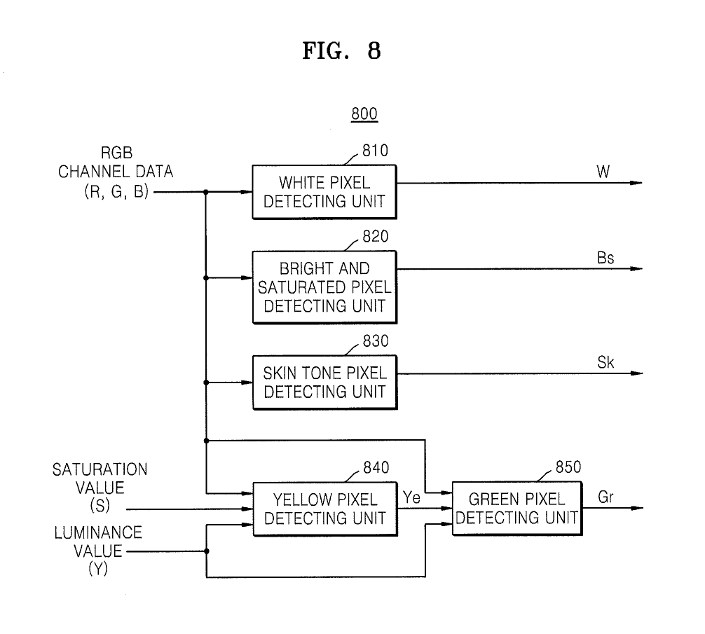

The pixel classifying unit 723 may classify at least one pixel included in one frame received by the pixel-by-pixel color component characteristic detecting unit 720 according to characteristics, pixel by pixel. The pixel classifying unit 723 may classify each of at least one pixel by using, of each pixel, the saturation value S detected by the saturation detecting unit 721, the luminance value Y detected by using the luminance detecting unit 722, and the RGB channel data R, G, and B. For example, whether a pixel is a white, bright and saturated, skin tone, yellow, or green pixel may be determined. A method of classifying at least one pixel according to characteristics that is performed by the pixel classifying unit 723 will be explained below in detail with reference to FIG. 8.

FIG. 8 is a block diagram illustrating a pixel classifying unit 800 of a pixel-by-pixel color component characteristic detecting unit, according to an embodiment of the present invention.

The pixel classifying unit 800 of FIG. 8 may correspond to the pixel classifying unit 723 of FIG. 7.

The pixel classifying unit 800 may include a white pixel detecting unit 810, a bright and saturated pixel detecting unit 820, a skin tone pixel detecting unit 830, a yellow pixel detecting unit 840, and a green pixel detecting unit 850.

The white pixel detecting unit 810 may determine whether a pixel may be recognized by a human as a white pixel by using an RGB channel data value of a pixel. In this case, the white pixel detecting unit 8140 may determine whether a pixel is a white pixel by using Equation 3. The white pixel detecting unit 810 may output a value ‘True’ or ‘False’ according to a result of the determination.

W=(S_{RGB}>384) [symbol] (M1−M0<30), S_{RGB}=R+G+B (3),

where [symbol] is an intersection set.

A pixel which satisfies both ‘S_{RGB}>384’ and ‘M1−M0<30’ may be determined to be a white pixel, and an output value W may be ‘True’. When it is determined that a pixel is not a white pixel, an output value W may be ‘False’.

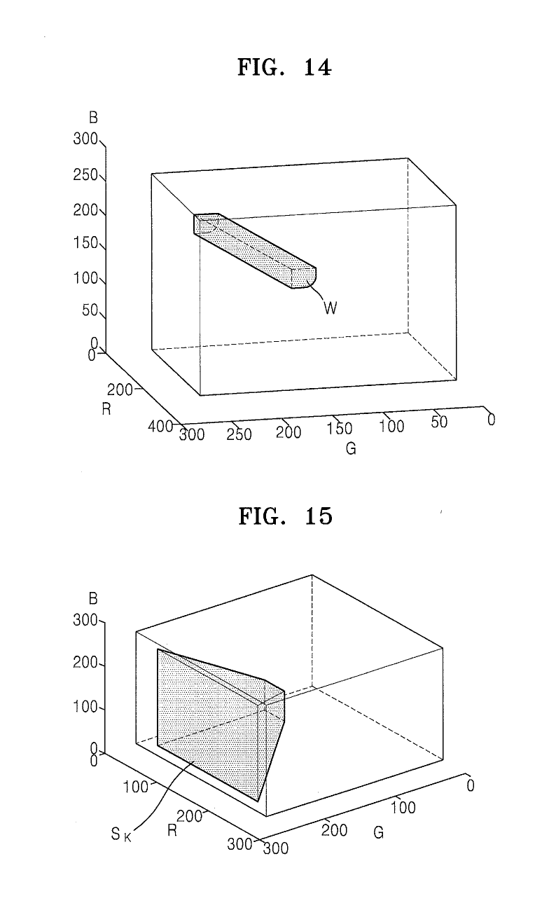

FIG. 14 is a graph illustrating a range of RGB channel data values in which a pixel may be determined to be a white pixel, according to an embodiment of the present invention.

The bright and saturated pixel detecting unit 820 may determine whether a pixel may be recognized by a human as a bright and saturated pixel by using an RGB channel data value of a pixel. In this case, the bright and saturated pixel detecting unit 820 may determine whether a pixel is a bright and saturated pixel by using Equation 4. The bright and saturated pixel detecting unit 820 may output a value ‘True’ or ‘False’ according to a result of the determination.

$${B}_{s} = ( M 1 > 150 ) ⋀ ( M 1 - M 0 \geq \frac{M 1}{2} ) . \qquad ( 4 )$$

A pixel that satisfies both

$$‘ M 1 > 150 ’ and ‘ M 1 - M 0 \geq \frac{M 1}{2} ’$$

in Equation 4 may be determined to be a bright and saturated pixel, and an output value Bₛ may be ‘True’. When it is determined that a pixel is not a bright and saturated pixel, the output value Bₛ may be ‘False’.

The skin tone pixel detecting unit 830 may determine whether a pixel may be recognized by a human as a skin tone pixel by using an RGB channel data value of a pixel. In this case, the skin tone pixel detecting unit 830 may determine whether a pixel is a skin tone pixel by using Equation 5.

$${S}_{k} = ( G \neq 0 ) ⋀ ( B \leq G + \frac{G}{2} ) ⋀ ( {S}_{RGB} > \frac{267 R}{{2}^{7}} ) ⋀ ( B \leq \frac{83 \cdot {S}_{RGB}}{{2}^{8}} ) ⋀ ( G \leq \frac{83 \cdot {S}_{RGB}}{{2}^{8}} ) . \qquad ( 5 )$$

A pixel that satisfies all of

$$‘ G \neq 0 ’ , ‘ B \leq G + \frac{G}{2} ’ , ‘ {S}_{RGB} > \frac{267 R}{{2}^{7}} ’ , ‘ B \leq \frac{83 \cdot {S}_{RGB}}{{2}^{8}} ’ , and$$

$$‘ G \leq \frac{83 \cdot {S}_{RGB}}{{2}^{8}} ’$$

in Equation 5 may be determined to be a skin tone pixel. An output value Sₖ may be ‘True’. When it is determined that a pixel is not a skin tone pixel, the output value Sₖ may be ‘False’.

FIG. 15 is a graph illustrating a range of RGB channel data values in which a pixel may be determined to be a skin tone pixel, according to an embodiment of the present invention.

The yellow pixel detecting unit 840 may determine whether a pixel may be recognized by a human as a yellow pixel by using an RGB channel data value of a pixel. In this case, the yellow pixel detecting unit 840 may determine whether a pixel is a yellow pixel by using Equation 6. The yellow pixel detecting unit 840 may output a value ‘True’ or ‘False’ according to a result of the determination.

Yₑ=(B<G) [symbol] (B<R) [symbol] (9·(M1_{RG}−M0_{RG})<M0_{RG}−B) [symbol] (S>0.2) [symbol] (Y>110) (6)

where M1_{RG} is a larger value of a G channel value and an R channel value in an RGB channel data value of a pixel, and M0_{RG} is a smaller value of the G channel value and the R channel value.

A pixel which satisfies all of ‘B<G’, ‘B<R’, ‘9·(M1_{RG}−M0_{RG})<M0_{RG}−B’, ‘S>0.2’, and ‘Y>110’ in Equation 6 may be determined to be a yellow pixel, and an output value Yₑ may be ‘True’. When it is determined that a pixel is not a yellow pixel, the output value Yₑ may be ‘False’.

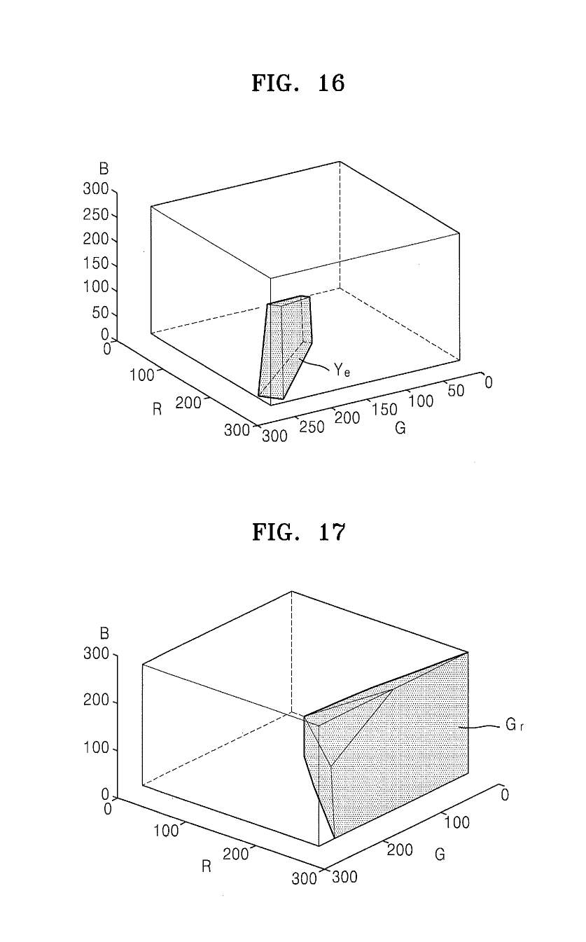

FIG. 16 is a graph illustrating a range of RGB channel data values in which a pixel may be determined to be a yellow pixel, according to an embodiment of the present invention.

The green pixel detecting unit 850 may determine whether a pixel may be recognized by a human as a green pixel by using an RGB channel data value of a pixel from among pixels that are determined to be yellow pixels by the yellow pixel detecting unit 840. In this case, the green pixel detecting unit 850 may detect whether a pixel is a green pixel by using Equation 7. The green pixel detecting unit 850 may output a value ‘True’ or ‘False’ according to a result of the determination.

$${G}_{r} = ( G > M {1}_{RB} ) ⋀ ( {S}_{RGB} > 80 ) ⋀ ( ( R + B < \frac{3}{2} G ) ⋁ ( R + B < 255 ) ⋁ ( R - B < 35 ) ) ⋀ ( Y > 80 ) ⋀ {Y}_{e} , \qquad ( 7 )$$

where M1_{RB} is a larger value of an R channel value and a B channel value in an RGB channel data value of a pixel, and [symbol] is a union set.

A pixel that satisfies all of

$$‘ G > M {1}_{RB} ’ , ‘ {S}_{RGB} > 80 ’ , \\ ‘ ( R + B < \frac{3}{2} G ⋁ R + B < 255 ⋁ R - B < 35 ) ’ , ‘ Y > 80 ’ ,$$

and ‘Yₑ=1’ in Equation 7 may be determined to be a green pixel, and an output value Gᵣ may be ‘True’. When it is determined that a pixel is not a green pixel, the output value Gᵣ may be ‘False’.

A multiplexer 860 may integrate and output outputs of the white pixel detecting unit 810, the bright and saturated pixel detecting unit 820, and the skin tone pixel detecting unit 830 for all pixels.

FIG. 17 is a graph illustrating a range of RGB channel data values in which a pixel may be determined to be a green pixel, according to an embodiment of the present invention,

Referring back to FIG. 7, the luminance gradient detecting unit 724 of FIG. 7 may detect a gradient D_{Y} of a luminance value Y of each pixel by using the luminance value Y of each pixel detected by the luminance detecting unit 722. In this case, the gradient D_{Y} of the luminance value Y of each pixel may be detected by filtering the luminance value Y of each pixel by using a kernel K_{grad}=[0 0 1 0 0 −1].

In detail, an average value of values calculated by using a kernel in pixels that are arranged in a 1×7 matrix may be the gradient D_{Y} of the luminance value of each pixel.

For example, in pixels that are arranged in a 1×7 matrix, when a luminance value of a fourth pixel ‘p’ is Y1 and a luminance value of a seventh pixel is Y2, a gradient of a luminance value of the pixel ‘p’, which is detected by using a kernel, may be determined to be

$${D}_{Y} = \frac{Y 1 - Y 2}{7} .$$

The statistical analysis unit 725 may analyze a characteristic of one frame received by the pixel-by-pixel color component characteristic detecting unit 720 according to color component characteristics of pixels included in the frame. The statistical analysis unit 725 may analyze a characteristic of a frame by using a characteristic of each pixel detected by the pixel classifying unit 723 and a gradient of a luminance value of each pixel detected by the luminance gradient detecting unit 724. In this case, the characteristic of the frame may be classified into 10 characteristics: a number F₁ of green pixels, a number F₂ of skin tone pixels, an average luminance value F₃, an average F₄ of a gradient of a luminance value of the green pixels, a number F₅ of bright and saturated pixels, an average saturation value F₆ of the green pixels, a number F₇ of white pixels, an average brightness value F₈ of the green pixels, an average value F₉ of a B channel value of the green pixels, and a relative width F₁₀ of a luminance histogram of the green pixels. An output value of the statistical analysis unit 725 may be (F₁, F₂, F₃, F₄, F₅, F₆, F₇, F₈, F₉, F₁₀). F₁ through F₁₀ may be detected by using Equation 8. In Equation 8, w is a horizontal length of a frame, h is a vertical length of the frame, and i, j are pixel coordinates.

$${F}_{1} = \frac{{\sum }_{i = 1 … w , j = 1 … h} δ ( {G}_{r} ( i , j ) )}{w \cdot h} , \\ {F}_{2} = \frac{{\sum }_{i = 1 … w , j = 1 … h} δ ( {S}_{k} ( i , j ) )}{w \cdot h} \\ {F}_{3} = \frac{{\sum }_{i = 1 … w , j = 1 … h} Y ( i , j )}{w \cdot h} \\ {F}_{4} = \frac{{\sum }_{i = 1 … w , j = 1 … h} \vert {D}_{Y} ( i , j ) \vert \cdot δ ( {G}_{r} ( i , j ) )}{{\sum }_{i = 1 … w , j = 1 … h} δ ( {G}_{r} ( i , j ) )} \\ {F}_{5} = \frac{{\sum }_{i = 1 … w , j = 1 … h} δ ( {B}_{s} ( i , j ) )}{w \cdot h} \\ {F}_{6} = \frac{{\sum }_{i = 1 … w , j = 1 … h} S ( i , j ) \cdot δ ( {G}_{r} ( i , j ) )}{{\sum }_{i = 1 … w , j = 1 … h} δ ( {G}_{r} ( i , j ) )} \\ {F}_{7} = \frac{{\sum }_{i = 1 … w , j = 1 … h} δ ( W ( i , j ) )}{w \cdot h} \\ {F}_{8} = \frac{{\sum }_{i = 1 … w , j = 1 … h} Y ( i , j ) \cdot δ ( {G}_{r} ( i , j ) )}{{\sum }_{i = 1 … w , j = 1 … h} δ ( {G}_{r} ( i , j ) )} \\ {F}_{9} = \frac{{\sum }_{i = 1 … w , j = 1 … h} B ( i , j ) \cdot δ ( {G}_{r} ( i , j ) )}{{\sum }_{i = 1 … w , j = 1 … h} δ ( {G}_{r} ( i , j ) )} \\ {F}_{10} = \frac{{{\sum }_{i = {P}_{8} - D / 8}}^{{P}_{8} + D / 8} {H}_{YGr} ( i )}{{\sum }_{i = 0}^{255} {H}_{YG r} ( i )} , \qquad ( 8 )$$

where H_{YGr} in F₁₀ is a luminance histogram of green pixels, and D is a width of a graph of the histogram, that is, a difference between a minimum value and a maximum value.

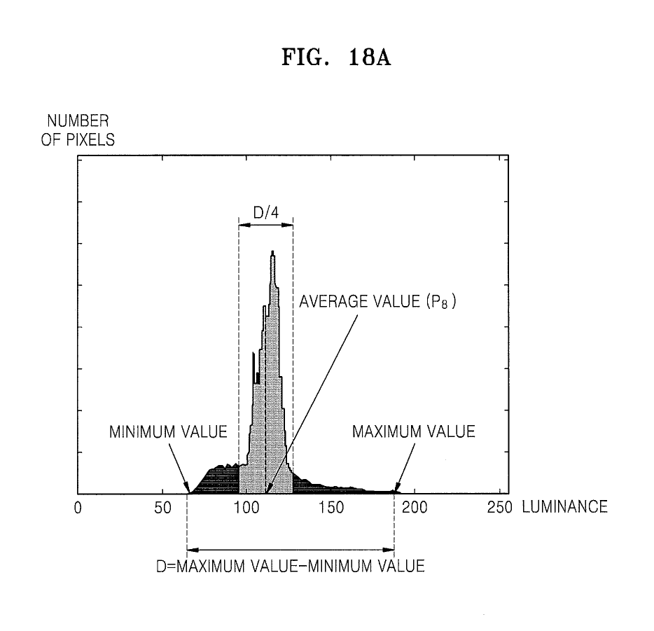

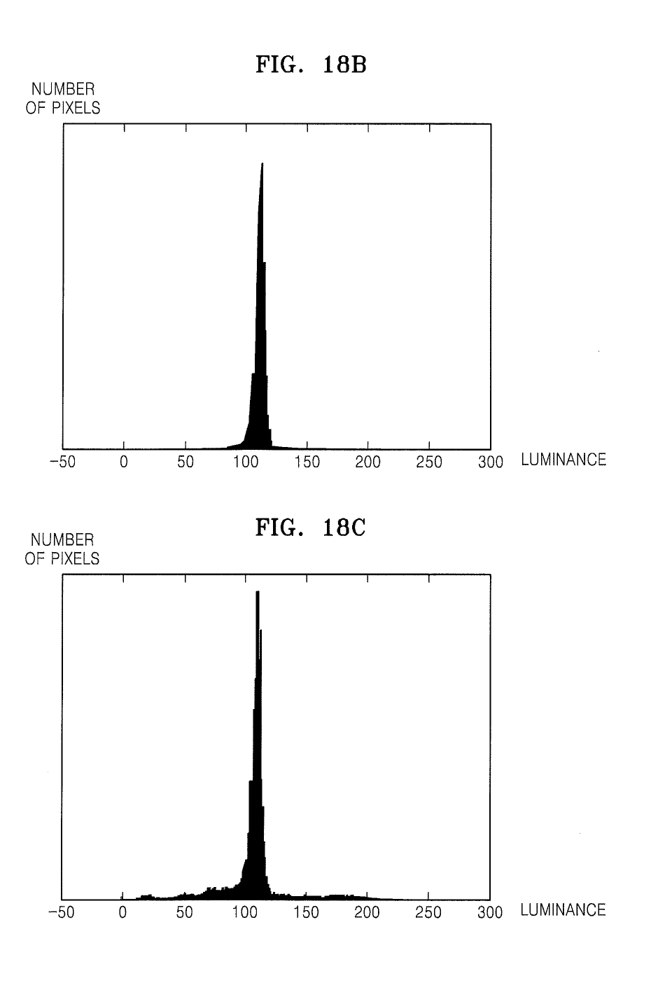

FIG. 18A is a luminance graph of green pixels, according to an embodiment of the present invention.

In the graph of FIG. 18A, a horizontal axis represents a luminance value and a vertical axis represents a number of green pixels. In this case, a value obtained by subtracting a minimum luminance value from a maximum luminance value from among luminance values of the green pixels may be D, and an average value of the luminance values of the green pixels may be P₈.

FIG. 18B is a luminance graph of green pixels of an image corresponding to a field game episode, according to an embodiment of the present invention. FIG. 18C is a luminance graph of green pixels of an image not corresponding to a field game episode, according to an embodiment of the present invention.

It is found that a width D of a histogram of FIG. 18B is small, a width D of FIG. 18C is large, and luminance values of the green pixels of FIG. 18C are widely spread. Accordingly, it is found that in an image including a field game episode, green pixels are mainly used to display a grass field in the image and thus luminance values are gathered in a narrow range.

Also, δ(x) may be defined as

$$δ ( x ) = \{ \begin{matrix}0 , & - x \\ 1 , & x .\end{matrix}$$

That is, when ‘x’ is ‘True’, it may mean 1, and when ‘x’ is ‘False’, it may mean 0.

FIG. 9 is a block diagram illustrating a type detecting unit 900 of a content type determination apparatus, according to an embodiment of the present invention. The type detecting unit 900 of FIG. 9 may correspond to each of the type detecting units 530 and 630 of FIGS. 5 and 6.

The type detecting unit 900 may include a type determining unit A 901 through a type determining unit M 912, and a type determining unit M 920. The type determining unit M 920 may determine a content type of a frame by using a value ‘True’ or ‘False’ output from the type determining units A 901 through L 912.

The type determining unit A 901 may detect a factor yᵢⱼ, which is necessary to determine a type of a content, by using a number F₁ of green pixels and an average saturation value F₆ of the green pixels. In this case, the type determining unit A 901 may detect the factor yᵢⱼ by using Equation 9.

In this case, integers 0 through 4 may be input into i, j, and T₀¹, T₁¹, T₂¹, T₄¹, T₀², T₁², T₂², T₃², T₄² may be arbitrarily determined as a predefined constant satisfying ‘T₀¹=0, T₄¹=1, T₀²=0, T₄²=0, T₀¹<T₁¹<T₂¹<T₃¹<T₄¹, and T₀²<T₁²<T₂²<T₃²<T₄²’.

yᵢⱼ=(F₁≧Tᵢ₋₁¹) [symbol] (F₁≦Tᵢ¹) [symbol] (F₂≧Tⱼ₋₁²) [symbol] (F₆≦Tⱼ²) (9)

The type determining unit A 901 may output yᵢⱼ=(y₁₁, y₁₂, y₁₃, y₁₄, y₂₁, y₂₂, y₂₃, y₂₄, y₃₁, y₃₂, y₃₃, y₃₄, y₄₁, y₄₂, y₄₃, y₄₄), and each output value may be ‘True’ or ‘False’.

The type determining unit B 902 may detect a factor N₁, which is necessary to determine a type of a content, by using an average luminance value F₃. In this case, the type determining unit B 902 may use Equation 10. T³ may be arbitrarily determined as a predefined constant satisfying ‘0<T³<1’.

N₁=F₁<T³ (10).

An output value N₁ of the type determining unit B 902 may be ‘True’ or ‘False’.

The type determining unit C 903 may detect a factor N₂, which is necessary to determine a type of a content, by using a number F₂ of skin tone pixels. In this case, the type determining unit C 903 may use Equation 11. T⁴ may be arbitrarily determined as a predefined constant satisfying ‘0<T⁴<1’.

N₂=F₂<T⁴ (11).

An output value N₂ of the type determining unit B 902 may be ‘True’ or ‘False’.

The type determining unit D 904 may detect a factor N₃, which is necessary to determine a type of a content, by using an average F₄ of a gradient of a luminance value of green pixels. In this case, the type determining unit D 904 may use Equation 12. T⁵ may be arbitrarily determined as a predefined constant satisfying ‘0<T⁵<1’.

N₃=F₄<T⁵ (12).

An output value N₃ of the type determining unit D 904 may be ‘True’ or ‘False’.

The type determining unit E 905 may detect a factor N₄, which is necessary to determine a type of a content by using a number F₇ of white pixels. In this case, the type determining unit E 905 may use Equation 13. T⁶ may be arbitrarily determined as a predefined constant satisfying ‘0<T⁶<1’.

N₄=F₇>T⁶ (13).

An output value N₄ of the type determining unit E 905 may be ‘True’ or ‘False’.

The type determining unit K 911 may detect a factor Zᵢⱼ, which is necessary to determine a type of a content, by using a number F₂ of skin tone pixels and a number F₅ of bright and saturated pixels. In this case, the type determining unit K 911 may use Equation 14.

In this case, an integer 1 or 2 may be input into i, j, and T₀⁷, T₁⁷, T₂⁷, T₀⁸, T₁⁸, T₂⁸ and may be arbitrarily determined as a predefined constant satisfying ‘‘T₀⁷=0’, ‘T₂⁷=1’, ‘T₀⁸=0’, ‘T₂⁸=1’, ‘T₀⁷<T₁⁷<T₂⁷’, and ‘T₀⁸<T₁⁸<T₂⁸’.

zᵢⱼ=(F₂≧Tᵢ₋₁⁷) [symbol] (F₂≦Tᵢ⁷) [symbol] (F₅≧Tⱼ₋₁⁸) [symbol] (F₅≦Tⱼ⁸) (14).

The type determining unit K 911 may output Zᵢⱼ=(z₁₁, z₁₂, z₂₁, z₂₂), and each output value may be ‘True’ or ‘False’.

The type determining unit L 912 may detect a factor Q₁, which is necessary to determine a type of a content, by using a number F₅ of bright and saturated pixels and an average luminance value F₃. In this case, the type determining unit E 905 may use Equation 15. K₁, K₂, and B may be arbitrarily determined as predefined constants.

Q₁=K₁·F₃+K₂·F₅+B>0 (15).

An output value Q₁ of the type determining unit L 912 may be ‘True’ or ‘False’.

The type determining unit F 906 may detect a factor Q₂, which is necessary to determine a type of a content, by using a number F₅ of bright and saturated pixels. In this case, the type determining unit F 906 may use Equation 16. T⁹ may be arbitrarily determined as a predefined constant satisfying ‘0<T⁹<1’.

Q₂=F₅>T⁹ (16).

An output value Q₂ of the type determining unit F 906 may be ‘True’ or ‘False’.

The type determining unit G 907 may detect a factor P₁, which is necessary to determine a type of a content, by using an average brightness value F₈ of green pixels. In this case, the type determining unit G 907 may use Equation 17. T⁴⁰ may be arbitrarily determined as a predefined constant satisfying ‘0<T¹⁰<1’.

P₁=F₈>T¹⁰, (17).

An output value P₁ of the type determining unit G 907 may be ‘True’ or ‘False’.

The type determining unit H 908 may detect a factor P₂, which is necessary to determine a type of a content, by using an average brightness value F₈ of green pixels. In this case, the type determining unit H 908 may use Equation 18. T¹¹ may be arbitrarily determined as a predefined constant satisfying ‘0<T¹¹<1, T¹¹ ≠T¹⁰’.

P₂=F₈>T¹¹ (18).

An output value P₂ of the type determining unit H 908 may be ‘True’ or ‘False’.

The type determining unit I 909 may detect a factor P₃, which is necessary to determine a type of a content, by using an average value F₉ of a B channel value of green pixels. In this case, the type determining unit I 909 may use Equation 19. T¹² may be arbitrarily determined as a predefined constant satisfying ‘0<T¹²<1’.

P₃=F₉<T¹², (19).

An output value P₃ of the type determining unit I 909 may be ‘True’ or ‘False’.

The type determining unit J 910 may detect a factor P₄, which is necessary to determine a type of a content, by using a width F₁₀ of a luminance histogram of green pixels. In this case, the type determining unit J 910 may use Equation 20. T¹³ may be arbitrarily determined as a predefined constant satisfying ‘0<T¹³<1’.

P₄=F₁₀<T¹³ (20).

An output value P₄ of the type determining unit J 910 may be ‘True’ or ‘False’.

The type determining unit M 920 may detect whether a content type of a frame is a field game by using output values yᵢⱼ, N₁, N₂, N₃, N₄, Zᵢⱼ, Q₁, Q₂, P₁, P₂, P₃, and P₄ of the type determining unit A 901 through the type determining unit J 910. In this case, the type determining unit M 920 may use Equation 21.

When V₁=N₁ [symbol] N₂ [symbol] N₃ [symbol] N₄ [symbol] z₁₁ and V₂=(y₂₂ [symbol] Q₂) [symbol] y₂₃ [symbol] (y₂₄ [symbol] Q₁) [symbol] y₃₂ [symbol] y₃₃ [symbol] y₃₄ [symbol] y₄₂ [symbol] y₄₃ [symbol] y₄₄, R=( [symbol] V₁) [symbol] P₁ [symbol] P₄ [symbol] V₂ [symbol] (P₂ [symbol] ( [symbol] P₂ [symbol] P₃)) (21).

An output value R of the type determining unit M 920 may be ‘True’ or ‘False’. That is, when the output value R is ‘True’, a frame of a video content may be determined to be of a field game, and when the output value R is ‘False, the frame of the content may be determined to be of a non-field game.

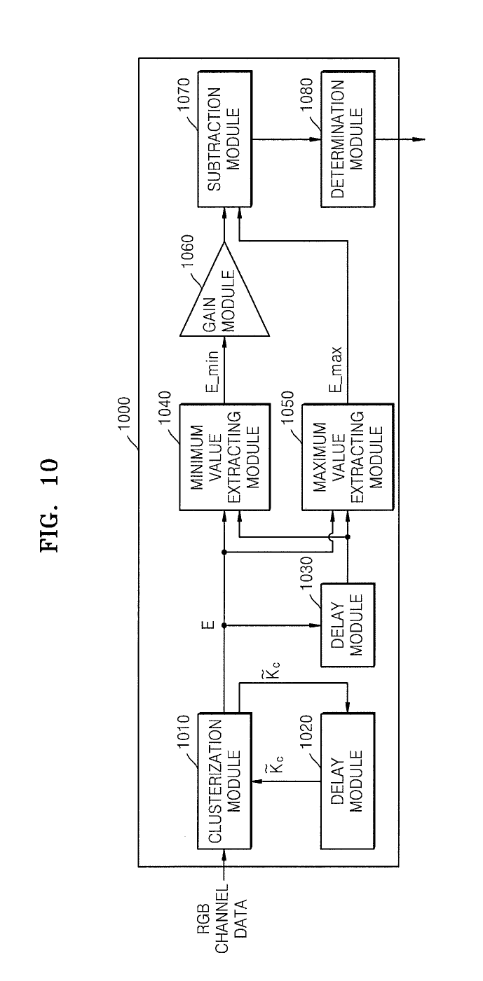

FIG. 10 is a block diagram illustrating a scene change detecting unit 1000 of a content type determination apparatus, according to an embodiment of the present invention. The scene change detecting unit 1000 of FIG. 10 may correspond to the scene change detecting unit 640 of FIG. 6.

The scene change detecting unit 1000 may include a clusterization module 1010, delay modules 1020 and 1030, a minimum value extracting module 1040, a maximum value extracting module 1050, a gain module 1060, a subtraction module 1070, and a determination module 1080. The clusterization module 1010 may classify and clusterize one or more pixels according to an RGB channel data value of each pixel, and may detect a cumulative error that may be used to determine whether a scene change occurs by using a cluster center from among the clusterized pixels. When a number of clusters is N_{K}, cluster centers K_{C} may be as shown in Equation 22.

$${K}_{C} = ( \begin{matrix}{R}_{1}^{C} & {R}_{2}^{C} & {R}_{3}^{C} & … & {R}_{{N}_{K}}^{C} \\ {G}_{1}^{C} & {G}_{2}^{C} & {G}_{3}^{C} & … & {G}_{{N}_{K}}^{C} \\ {B}_{1}^{C} & {B}_{2}^{C} & {B}_{3}^{C} & … & {B}_{{N}_{K}}^{C}\end{matrix} ) , \qquad ( 22 )$$

where R₁^{C}, G₁^{C}, and B₁^{C} may be RGB channel data values of a pixel which is a cluster center. The cluster center may be one of pixels included in one cluster.

The clusterization module 1010 may detect a cumulative error E that may be used to determine whether a scene change occurs by using a cluster center of each pixel as shown in Equation 23.

$$When P ( i , j ) = ( R ( i , j ) G ( i , j ) B ( i , j ) ) , \\ {C}_{k} = ( {R}_{k}^{C} {G}_{k}^{C} {B}_{k}^{C} ) , and \\ D ( x , y ) = ‖ x - y ‖ , \\ K ( i , j ) = arg {min}_{k = 1 … {N}_{k}} D ( P ( i , j ) , {C}_{k} ) \\ E = {\sum }_{{i = 1 … w}_{j = 1 … h}} D ( P ( i , j ) , {C}_{K ( i , j )} ) . \qquad ( 23 )$$

Updated cluster centers \tilde{K}_{C} may be as shown in Equation 24. The clusterization module 1010 may detect a cumulative error E that may be used to determine whether a scene change occurs by using the updated cluster centers \tilde{K}_{C}. That is, the clusterization module 1010 may obtain a cumulative error E for pixels of a next frame by using the updated cluster centers \tilde{K}_{C} according to Equation 23.

$$When {\tilde{R}}_{k}^{C} = \frac{{\sum }_{{i = 1 … w ,}_{j = 1 … h}} δ ( K ( i , j ) = k ) \cdot R ( i , j )}{{\sum }_{{i = 1 … w ,}_{j = 1 … h}} δ ( K ( i , j ) = k )} , \\ {\tilde{G}}_{k}^{C} = \frac{{\sum }_{{i = 1 … w ,}_{j = 1 … h}} δ ( K ( i , j ) = k ) \cdot G ( i , j )}{{\sum }_{{i = 1 … w ,}_{j = 1 … h}} δ ( K ( i , j ) = k )} , and \\ {\tilde{B}}_{k}^{C} = \frac{{\sum }_{{i = 1 … w ,}_{j = 1 … h}} δ ( K ( i , j ) = k ) \cdot R ( i , j )}{{\sum }_{{i = 1 … w ,}_{j = 1 … h}} δ ( K ( i , j ) = k )} , \\ {\tilde{K}}_{C} = ( \begin{matrix}{\tilde{R}}_{1}^{C} & {\tilde{R}}_{2}^{C} & {\tilde{R}}_{3}^{C} & … & {\tilde{R}}_{{N}_{k}}^{C} \\ {\tilde{G}}_{1}^{C} & {\tilde{G}}_{2}^{C} & {\tilde{G}}_{3}^{C} & … & {\tilde{G}}_{{N}_{k}}^{C} \\ {\tilde{B}}_{1}^{C} & {\tilde{B}}_{2}^{C} & {\tilde{B}}_{3}^{C} & … & {\tilde{B}}_{{N}_{k}}^{C}\end{matrix} ) . \qquad ( 24 )$$

The scene change detecting unit 1000 may use an error value of a previous frame and an error value of a next frame in order to determine whether a scene change is detected.

The delay module 1030 may store an error value of a previous frame received from the clusterization module 1010, and may output the error value to the minimum value extracting module 1040 and the maximum value extracting module 1050.

The minimum value extracting module 1040 may output a smaller value E_min of an error value of a next frame and the error value of the previous frame, and the maximum value extracting module 1050 may output a larger value E_max of the error value of the next frame and the error value of the previous frame. The gain module 1060 may output a value obtained by multiplying an input value by a constant greater than 1, and the subtraction module 1070 may perform a subtraction of an input value and output a resultant value.

The determination module 1080 may determine whether a scene change occurs by comparing ‘E_max−a*E_min’ with a predefined value. * denotes a multiplication, and ‘a’ is a constant greater than 1. For example, when ‘E_max−a*E_min’ is less than the predefined value, it may be determined that a scene change does not occur. The determination module 1080 may output a value ‘True’ or ‘False’ according to whether a scene change occurs.

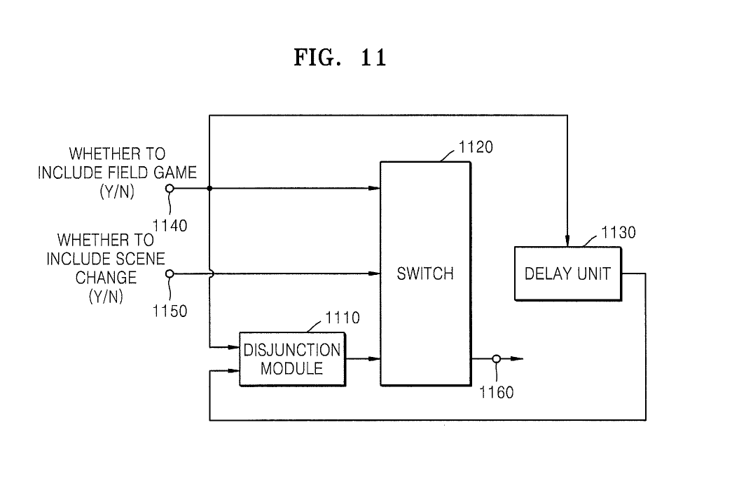

FIG. 11 is a block diagram illustrating a final type detecting unit 1100 of a content type determination apparatus, according to an embodiment of the present invention. The final type detecting unit 1100 of FIG. 11 may correspond to the final type detecting unit 650 of FIG. 6.

The final type detecting unit 1100 may include a disjunction module 1110, a switch 1120, and a delay unit 1130.

The disjunction module 1110 may output a value ‘True’ when one or more values ‘True’ are included in an input value. That is, the disjunction module 1110 may output a value ‘True’ when type values of a previous frame and a current frame detected by the determination module 1080 include ‘True’.

The delay unit 1130 may store a type value of the previous frame detected by the determination module 1080, and may output the stored type value when a type value of the current frame is detected.

The switch 1120 may detect and output a content type 1160 of the current frame according to a value 1150 indicating whether a scene change occurs. In this case, information about whether a scene change occurs may be included in content data.

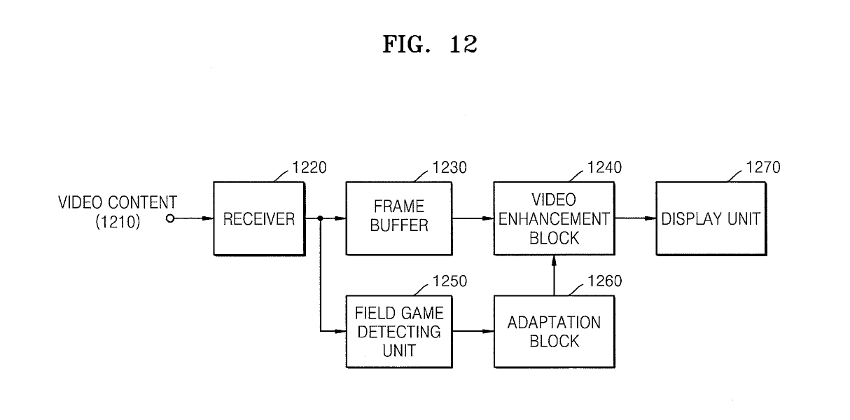

The value 1150 indicating whether a scene change occurs may be ‘True’ or ‘False’. ‘True’ may be a value output when a scene change occurs and ‘False’ may be a value output when a scene change does not occur. The switch 1120 may output a detected type value 1140 of the current frame when the value 1150 indicating whether a scene change occurs is ‘True’, and may output an output value of the disjunction module 1110 when the output value 1150 of the scene change detecting unit 640 is ‘False’. FIG. 12 is a block diagram illustrating a content type determination system according to an embodiment of the present invention.

Referring to FIG. 12, the content type determination system may include a receiver 1220, a frame buffer 1230, a video enhancement block 1240, a field game detecting unit 1250, an adaptation block 1260, and a display unit 1270.

The receiver 1220 may receive a video content 1210 from the outside and output the video content 1210.

The frame buffer 1230 may store the video content 1210 received from the receiver 1220 and output the video content 1210 one frame by one frame.

The video enhancement block 1240 may process the video content 1210 received from the frame buffer 1230. For example, the video enhancement block 1240 may perform noise reduction, contrast enhancement, or sharpening on the video content 1210.

The field game detecting unit 1250 may detect a content type of each frame by determining whether each frame is a field game by using the video content 1210 received from the receiver 1220. In this case, a method of determining a content type, which is performed by each of the content type determination apparatuses 500 and 600, may apply to a method of detecting a content type of each frame, which is performed by the field game detecting unit 1250.

The adaptation block 1260 may provide information necessary to process the video content 1210 to the video enhancement block 1240 such that the video enhancement block 1240 may process the video content 1210 according to the content type detected by the field game detecting unit 1250.

The display unit 1270 may display the video content 1210 processed by the video enhancement block 1240.

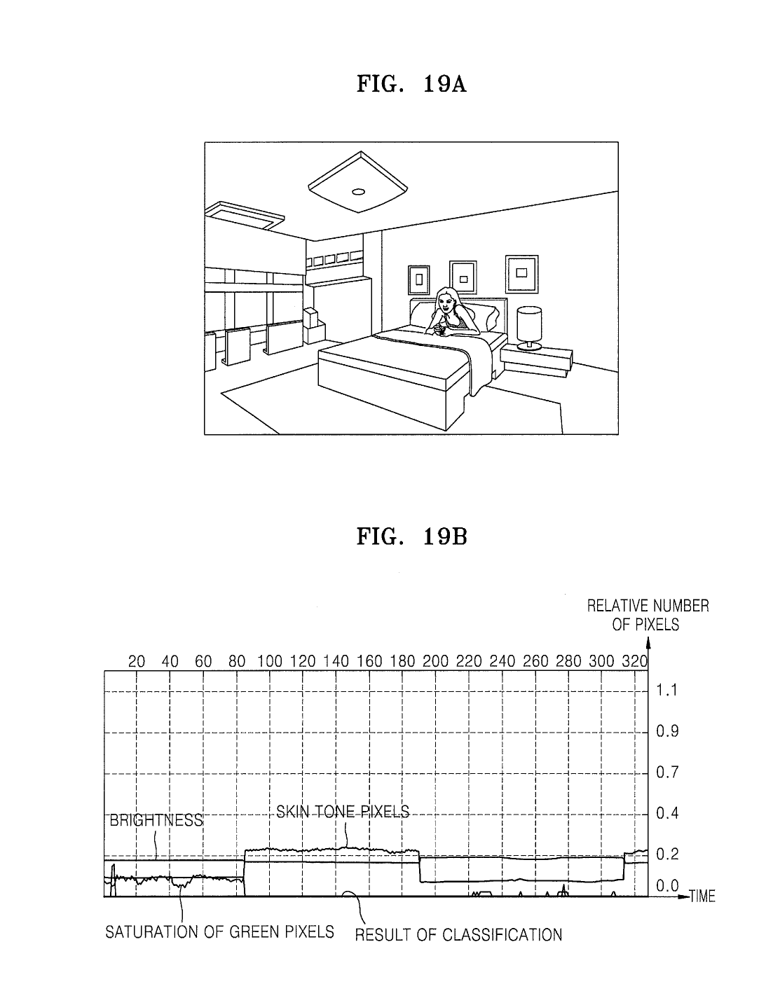

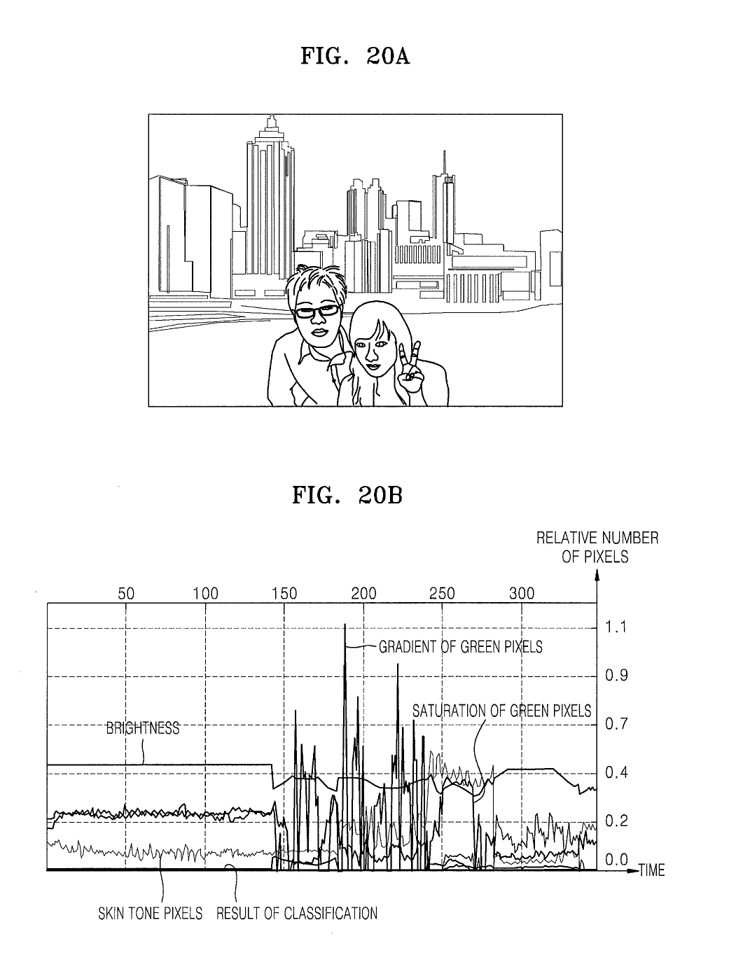

FIGS. 19A through 20B illustrate images not corresponding to a field game episode and graphs of the images, according to embodiments of the present invention.

Referring to FIGS. 19B and 20B, it is found that the images of FIGS. 19A and 20A are not a field game episode because a proportion of green pixels is low.

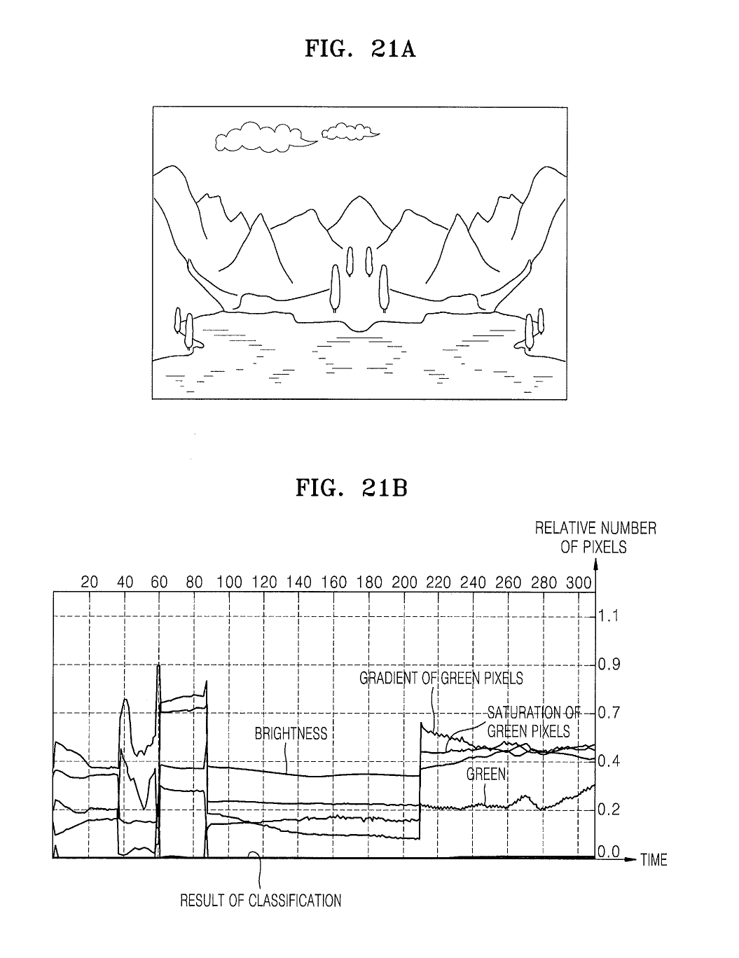

FIG. 21A illustrates an image not corresponding to a field game episode and a graph of the image, according to another embodiment of the present invention.

Referring to FIG. 21B, it is found that the image of FIG. 21A is a non-field game episode because an average proportion of green pixels is low. Although there is an area where a proportion of green pixels is high in the graph of FIG. 21B, since when a current frame and a previous frame are determined to belong to the same scene according to content information, a type of the current frame is determined according to a type of the previous frame, the previous frame is not a field game episode and thus the current frame is determined to be a non-field game episode.

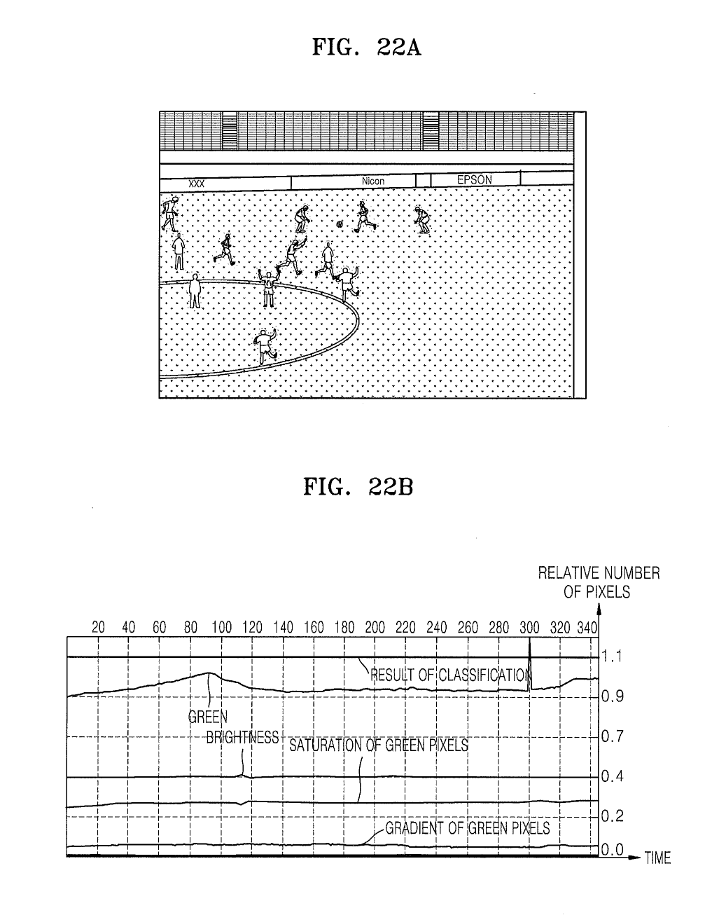

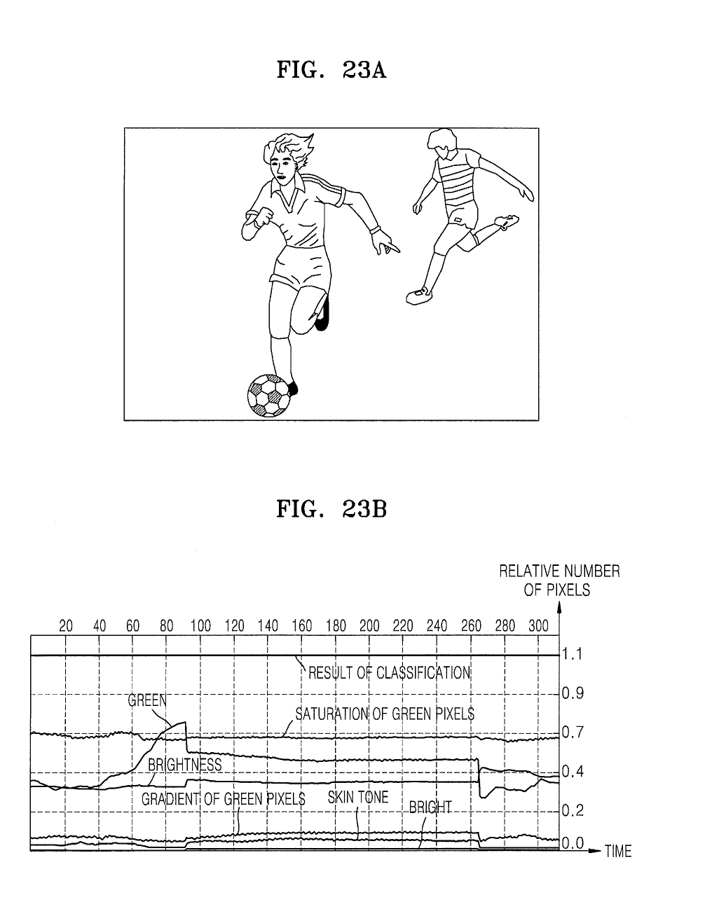

FIGS. 22A through 23B illustrate images corresponding to a field game episode and graphs of the images, according to embodiments of the present invention.

Referring to FIG. 22B, it is found that since a proportion of green pixels is high, and a proportion of bright and saturated pixels and a proportion of white pixels or skin tone pixels are relatively low, the image of FIG. 22A is determined to be a field game episode of a far view.

Referring to FIG. 23B, it is found that since a number of green pixels is relatively low, a number of bright and saturated pixels is high, a number of bright or white pixels is low, and a number of skin tone pixels is greater than 0 but very low, the image of FIG. 23A is determined to be a field game episode of a close-up view.

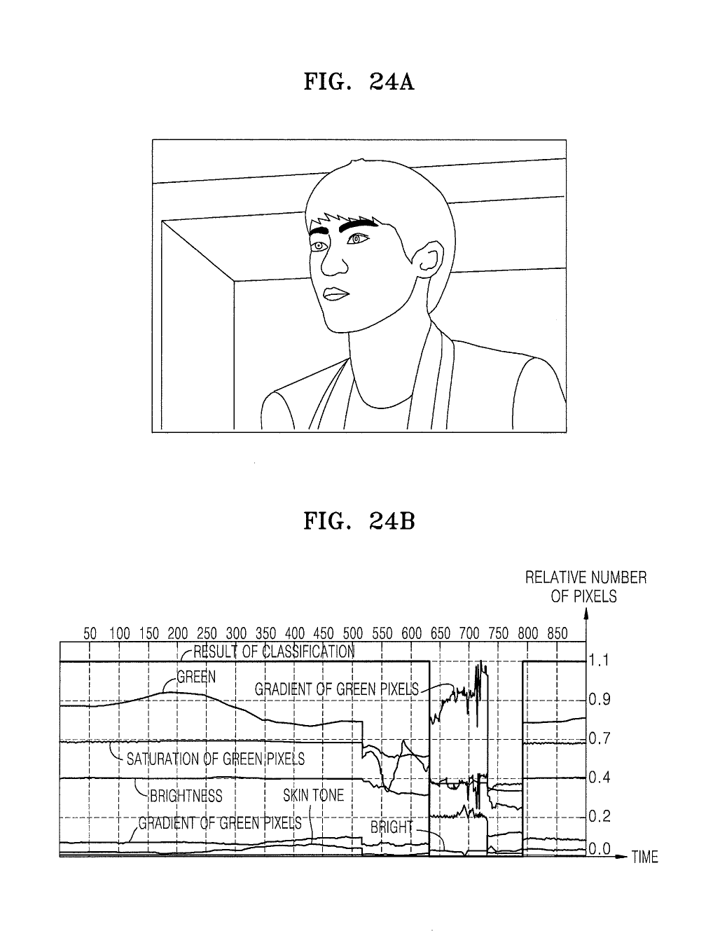

FIG. 24A illustrates an image that is determined to be a non-field game episode and is inserted between an image determined to be a non-field game episode and an image corresponding to a field game episode, and FIG. 24B illustrates a graph of the image.

Referring to FIG. 24B, it is found that since a number of green pixels is very low, the image of FIG. 24A is determined to be a non-field game episode. However, it is found that previous or next scenes of the image are determined to be a field game episode. Although belonging to one scene of a field game episode, the image of FIG. 24A may be determined to be a non-field game episode since a grass field is not displayed and a number of green pixels is very low. Accordingly, a content type determination apparatus according to the present embodiment may determine whether a corresponding frame and a previous frame belong to the same scene. When it is determined that the corresponding frame and the previous frame belong to the same scene, the content type determination apparatus may determine a content type of the corresponding frame according to a content type of the previous frame.

According to the present invention, since a content type may be determined frame by frame, the content type may be determined in real time.

According to the present invention, a content type of a video content may be determined at the same level as that recognized by a human.

Also, since functions used to determine a content type of a video content are linear and logical, and thus may simply and rapidly implemented, a content type may be determined in real time frame by frame.

The present invention may be embodied as computer-readable codes that may be read by a computer, which is any device having an information processing function on a computer-readable recording medium. The computer-readable recording medium includes any storage device that may store data that may be read by a computer system. Examples of the computer-readable recording medium include read-only memories (ROMs), random-access memories (RAMs), CD-ROMs, magnetic tapes, floppy disks, and optical data storage devices.

While the present invention has been particularly shown and described with reference to exemplary embodiments thereof by using specific terms, the embodiments and terms have merely been used to explain the present invention and should not be construed as limiting the scope of the present invention as defined by the claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of determining a content type of a video content, the method comprising:
receiving a frame of the video content;
detecting a pixel-by-pixel color component characteristic of the received frame; and
determining a content type of the received frame according to the detected pixel-by-pixel color component characteristic, wherein the determining indicates whether the received frame includes a content that reproduces a scene of a predetermined genre.

2. The method of claim 1, wherein when the received frame and a previous frame belong to a same scene, the method further comprises determining the content type of the received frame according to a content type of the previous frame.

3. The method of claim 1, wherein the detecting of the pixel-by-pixel color component characteristic of the received frame comprises:
detecting a luminance and a saturation of each of a plurality of pixels included in the received frame;
detecting the pixel-by-pixel color component characteristic by using the detected luminance and the detected saturation and an RGB channel value of the each of the plurality of the pixels;
detecting a gradient of the luminance of the each of the plurality of the pixels by respectively using the detected luminance of the each of the plurality of the pixels; and
detecting a statistical analysis value of the received frame by using the detected gradient of the luminance of the each of the plurality of the pixels and the pixel-by-pixel color component characteristic detected by using the detected luminance and the detected saturation and the RGB channel value of the each of the plurality of the pixels.

4. The method of claim 3, wherein the detecting of the statistical analysis value of the received frame comprises:
detecting a statistical analysis value of the plurality of the pixels included in the received frame; and
detecting a statistical analysis value of pixels whose pixel-by-pixel color component characteristic is green from among the plurality of the pixels included in the received frame.

5. The method of claim 4, wherein the detecting of the statistical analysis value of the plurality of the pixels included in the received frame comprises:
detecting a proportion of pixels whose pixel-by-pixel color component characteristic is white from among the plurality of the pixels included in the received frame;
detecting a proportion of pixels whose pixel-by-pixel color component characteristic is bright and saturated from among the plurality of the pixels included in the received frame;
detecting a proportion of pixels whose pixel-by-pixel color component characteristic is green from among the plurality of the pixels included in the received frame; and
detecting a proportion of pixels whose pixel-by-pixel color component characteristic is skin tone from among the plurality of the pixels included in the received frame.

6. The method of claim 4, wherein the detecting of the statistical analysis value of the pixels whose pixel-by-pixel color component characteristic is green from among the plurality of the pixels included in the received frame comprises:
detecting an average luminance value of a plurality of the pixels whose pixel-by-pixel color component characteristic is green from among the plurality of the pixels included in the received frame;
detecting an average saturation value of the plurality of the pixels whose pixel-by-pixel color component characteristic is green from among the plurality of pixels included in the received frame;
detecting an average B channel value of the plurality of the pixels whose pixel-by-pixel color component characteristic is green from among the plurality of pixels included in the received frame;
detecting an average luminance gradient of the plurality of the pixels whose pixel-by-pixel color component characteristic is green from among the plurality of pixels included in the received frame; and
detecting a histogram of a G channel of the plurality of pixels whose pixel-by-pixel color component characteristic is green from among the plurality of pixels included in the received frame;

7. The method of claim 1, wherein the determining of the content type of the received frame according to the detected pixel-by-pixel color component characteristic comprises, from among a plurality of pixels included in the received frame,
in at least one case from among
a case where a proportion of pixels whose pixel-by-pixel color component characteristic is green is equal to or less than a reference value,
a case where an average saturation value of the pixels whose pixel-by-pixel color component characteristic is green is equal to or less than a saturation reference value,
a case where the average saturation value of the pixels whose pixel-by-pixel color component characteristic is green is equal to or less than the saturation reference value, and an average value of a B channel of the pixels whose pixel-by-pixel color component characteristic is green is equal to or greater than a B channel reference value,
a case where the average saturation value or an average luminance value of the pixels whose pixel-by-pixel color component characteristic is green is equal to or less than the saturation reference value or a luminance reference value, respectively,
a case where the average saturation value of the pixels whose pixel-by-pixel color component characteristic is green is a value between a first reference value and a second reference value, and a width of a histogram of the pixels whose pixel-by-pixel color component characteristic is green is equal to or greater than a width reference value,
a case where the average saturation value of pixels whose pixel-by-pixel color component characteristic is green is equal to or greater than a reference value, and the width of the histogram of the pixels whose pixel-by-pixel color component characteristic is green is equal to or less than a reference value, and
a case where the average saturation value of the pixels whose pixel-by-pixel color component characteristic is green is equal to or greater than a reference value, and an average gradient of a luminance of the pixels whose pixel-by-pixel color component characteristic is green is equal to or less than a gradient reference value,
determining that the content type of the received frame is a non-field game.

8. The method of claim 1, wherein the determining of the content type of the received frame according to the detected pixel-by-pixel color component characteristic comprises, from among the plurality of the pixels included in the received frame:
in at least one case from among
a case where a proportion of pixels whose pixel-by-pixel color component characteristic is green is equal to or less than a reference value, a proportion of pixels whose pixel-by-pixel color component characteristic is bright and saturated is equal to or greater than the reference value, and a proportion of pixels whose pixel-by-pixel color component characteristic is white or a proportion of pixels whose pixel-by-pixel color component characteristic is skin tone is equal to or less than the reference value, and
a case where a proportion of pixels whose pixel-by-pixel color component characteristic is green is equal to or greater than reference value, a proportion of pixels whose pixel-by-pixel color component characteristic is bright and saturated is equal to or less than the reference value, and a proportion of the pixels whose pixel-by-pixel color component characteristic is white or a proportion of the pixels whose pixel-by-pixel color component characteristic is skin tone is equal to or less than the reference value,
determining that the content type of the received frame is a field game.

9. An apparatus for determining a content type of a video content, the apparatus comprising:
a frame buffer that receives a frame of the video content;
a pixel-by-pixel color component characteristic detecting unit that detects a pixel-by-pixel color component characteristic of the received frame; and
a content type detecting unit that determines a content type of the received frame according to the detected pixel-by-pixel color component characteristic, wherein the determining indicates whether the received frame includes a content that reproduces a scene of a predetermined genre.

10. The apparatus of claim 9, further comprising:
a scene change detecting unit that outputs information about whether the received frame and a previous frame belong to a same scene; and
a final type detecting unit that uses an output value of the scene change detecting unit to determine whether a final content type of the received frame is a content type of the previous frame or the content type of the received frame determined according to the pixel-by-pixel color component characteristic.

11. The apparatus of claim 9, wherein the pixel-by-pixel color component characteristic detecting unit comprises:
a luminance detecting unit that detects a luminance of each of a plurality of pixels included in the received frame;
a saturation detecting unit that detects a saturation of the each of the plurality of pixels included in the received frame;
a pixel classifying unit that detects the pixel-by-pixel color component characteristic by using the detected luminance and the detected saturation and a plurality of pixel values;
a luminance gradient detecting unit that detects a gradient of the luminance of the each of the plurality of pixels by respectively using a luminance value of the each of the plurality of pixels; and
a statistical analysis unit that detects a statistical analysis value of the received frame by using the detected gradient of the luminance of the each of the plurality of pixels and the pixel-by-pixel color component characteristic detected by the pixel classifying unit.

12. The apparatus of claim 11, wherein the statistical analysis unit detects a statistical analysis value of the plurality of the pixels included in the received frame and detects a statistical analysis value of pixels whose pixel-by-pixel color component characteristic is green from among the plurality of the pixels included in the received frame.

13. The apparatus of claim 12, wherein, from among the plurality of the pixels included in the received frame, the statistical analysis unit detects a proportion of pixels whose pixel-by-pixel color component characteristic is white, detects a proportion of pixels whose pixel-by-pixel color component characteristic is bright and saturated, detects a proportion of pixels whose pixel-by-pixel color component characteristic is green, and detects a proportion of pixels whose pixel-by-pixel color component characteristic is skin tone.

14. The apparatus of claim 12, wherein, from among the plurality of the pixels included in the received frame, the statistical analysis unit detects an average luminance value of a plurality of the pixels whose pixel-by-pixel color component characteristic is green, detects an average saturation value of the plurality of the pixels whose pixel-by-pixel color component characteristic is green, detects an average B channel value of the plurality of the pixels whose pixel-by-pixel color component characteristic is green, detects an average luminance gradient of the plurality of the pixels whose pixel-by-pixel color component characteristic is green, and detects a histogram of a G channel of the plurality of the pixels whose pixel-by-pixel color component characteristic is green.

15. The apparatus of claim 9, wherein, from among a plurality of pixels included in the received frame, the content type determining unit,
in at least one case from among
a case where a proportion of pixels whose pixel-by-pixel color component characteristic is green is equal to or less than a reference value,
a case where an average saturation value of the pixels whose pixel-by-pixel color component characteristic is green is equal to or less than a saturation reference value,
a case where the average saturation value of pixels whose pixel-by-pixel color component characteristic is green is equal to or less than the saturation reference value, and an average value of a B channel of the pixels whose pixel-by-pixel color component characteristic is green is equal to or greater than a B channel reference value,
a case where the average saturation value or an average luminance value of the pixels whose pixel-by-pixel color component characteristic is green is equal to or less than the saturation reference value, or a luminance reference value, respectively,
a case where the average saturation value of pixels whose pixel-by-pixel color component characteristic is green is a value between a first reference value and a second reference value, and a width of a histogram of the pixels whose pixel-by-pixel color component characteristic is green is equal to or greater than a width reference value,
a case where the average saturation value of pixels whose pixel-by-pixel color component characteristic is green is equal to or greater than a reference value, and the width of the histogram of the pixels whose pixel-by-pixel color component characteristic is green is equal to or less than a reference value, and
a case where the average saturation value of pixels whose pixel-by-pixel color component characteristic is green is equal to or greater than a reference value, and an average gradient of a luminance of the pixels whose pixel-by-pixel color component characteristic is green is equal to or less than a gradient reference value,
determines that the content type of the received frame is a non-field game.

16. The apparatus of claim 9, wherein, from among the plurality of the pixels included in the received frame, the content type determining unit,
in at least one case from among
a case where a proportion of pixels whose pixel-by-pixel color component characteristic is green is equal to or less than a reference value, a proportion of pixels whose pixel-by-pixel color component characteristic is bright and saturated is equal to or greater than reference value, and a proportion of pixels whose pixel-by-pixel color component characteristic is white or a proportion of pixels whose pixel-by-pixel color component characteristic is skin tone is equal to or less than reference value, and
a case where a proportion of pixels whose pixel-by-pixel color component characteristic is green is equal to or greater than a reference value, a proportion of pixels whose pixel-by-pixel color component characteristic is bright and saturated is equal to or less than reference value, and a proportion of pixels whose pixel-by-pixel color component characteristic is white or a proportion of the pixels whose pixel-by-pixel color component characteristic is skin tone is equal to or less than reference value,
determines that the content type of the received frame is a field game.

17. A non-transitory computer-readable recording medium having embodied thereon a program, which, when executed by a computer, performs a method of determining a content type of a video content, the method comprising:
receiving a frame of the video content;
detecting a pixel-by-pixel color component characteristic of the received frame; and
determining a content type of the received frame according to the detected pixel-by-pixel color component characteristic, wherein the determining indicates whether the received frame includes a scene of a predetermined genre.
